(19) United States
(12) Patent Application Publication
(10) Pub. No.: US 2025/0291647 A1
(43) Pub. Date: Sep. 18, 2025

(54) STARVATION AVOIDANCE IN AN OUT-OF-ORDER PROCESSOR

(71) Applicant: Akeana, Inc., Santa Clara, CA (US)

(72) Inventor: Ricardo Ramirez, Sunnyvale, CA (US)

(73) Assignee: Akeana, Inc., Santa Clara, CA (US)

(21) Appl. No.: 19/077,136

(22) Filed: Mar. 12, 2025

Related U.S. Application Data
(60) Provisional application No. 63/564,529, filed on Mar. 13, 2024.
(60) Provisional application No. 63/570,281, filed on Mar. 27, 2024.
(60) Provisional application No. 63/640,921, filed on May 1, 2024.
(60) Provisional application No. 63/641,045, filed on May 1, 2024.
(60) Provisional application No. 63/653,402, filed on May 30, 2024.
(60) Provisional application No. 63/679,192, filed on Aug. 5, 2024.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.

(51) Int. Cl. G06F 9/52; G06F 9/30

(52) U.S. Cl. CPC G06F 9/524; G06F 9/30087

(57) ABSTRACT

Techniques for processor management are disclosed. One or more processors are accessed. The one or more processors include one or more logical partitions. A processor from the one or more processors executes one or more instructions out of order. The processor detects a deadlock condition. The deadlock condition prevents the one or more instructions from completing. The deadlock condition occurs in a logical partition within the one or more logical partitions. A parallelism of execution in the logical partition is reduced. The reducing allows the one or more instructions to complete. The reducing is based on one or more control bits. Cessation of the deadlock condition is recognized. The parallelism of execution in the logical partition is restored. The restoring is based on the one or more control bits. The one or more instructions execute on one or more threads running on the processor.

### RELATED APPLICATIONS

This application claims the benefit of U.S. provisional patent applications “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, and “Transformed Activation Function With ISA Extension” Ser. No. 63/765,094, filed Feb. 28, 2025.

Each of the foregoing applications is hereby incorporated by reference in its entirety.

### FIELD OF ART

This application relates generally to avoiding deadlock and more particularly to starvation avoidance in an out-of-order processor.

### BACKGROUND

Travel of all kinds seems an inevitability for many people in the modern world. Travel enables people to move between and among many locations. The locations can be home and work or school, doctors' offices, retail establishments, food courts and restaurants, financial institutions, and all manner of destinations. Although many people started to work from home during the global Covid-19 Pandemic of 2020, and many people continue to do so today, in the United States alone, an estimated 1.1 billion trips are taken every day, averaging four trips per person per day. While these numbers can change based on a day of the week, holidays, or even the weather, the number of people involved in travel is a staggering one. Daily travel typically includes common obligations such as a daily commute to work, appointments, or school runs. Travel can be included in a job description such as for a delivery person or a flight attendant. Travel can include cultural travel, adventure travel, rural travel, and sports travel. And tragically, travel can result from displacement due to war, famine, and natural disaster.

Since a large portion of daily travel occurs on roads, and uses a variety of vehicles to do so, governments ranging from town and municipal ones to national ones have constructed vast networks of roads, and in some countries, rails. However, the number of travelers tends to increase each year, as does the number of vehicles that use the roads. As the roads become more congested, construction projects are initiated to expand existing roads and to add new ones. Ironically, the construction projects contribute further to the road congestion problems. As a result, travel can be difficult, frustrating, and at times dangerous. For example, traffic jams are frequent and annoying for many people who live in metropolitan areas. Even in smaller cities, towns, and villages, cars and trucks can clog up a vital road and cause havoc for hours or even days. In 2010, the Beijing-Tibet Expressway was blocked for 12 days as trucks carrying construction supplies were blocked at exits. The resulting lines of cars and trucks stretched for 62 miles. The famous Woodstock festival in New York in 1969 caused a three-day traffic jam. The world record for traffic jam distance goes to France. In 1980, a traffic jam of 109 miles led to numerous lives being disrupted. In many cases, the sheer volume of cars traveling together slows traffic flow. Any additional stressor that restricts the roadway or distracts drivers can bring traffic to a complete standstill.

Restriction of flow is not limited to the flow of cars, trucks, and other vehicles alone. Similar patterns are seen where the flow of a medium can be slowed or even stopped by volume, adverse conditions, or distractions. Liquid in pipes, air in a tunnel, or electrons moving through a silicon chip can all be subject to delays or even stoppage for much the same reasons as cars sitting still on a highway.

### SUMMARY

Processors of various types enable a wide range of devices to perform essential, useful, and desirable tasks and applications. The processors can use techniques for improving processing throughput by executing instructions out of order. The out-of-order execution can take advantage of sections of code that include the instructions that can be executed in parallel. As the processors are executing the out-of-order instructions, the devices can get into a deadlock condition when two or more instructions request access to a shared resource. A deadlock occurs when a first instruction requests access to a shared resource and sees that a second instruction is requesting access to the same resource. The first instruction begins to wait for the second instruction to complete. However, the second instruction sees the request issued by the first instruction and begins to wait for the first instruction to complete. Thus, both instructions are waiting and neither instruction completes. By detecting that such a deadlock condition has occurred, various techniques can be applied to resolve the deadlock. In disclosed techniques, having detected a deadlock condition, a parallelism of execution can be reduced within a logical partition. The logical partition can include a logical grouping of computational resources within a processor. The reducing parallelism of execution can include forcing instructions to execute in order, restarting instructions, and so on. When the deadlock condition is recognized to have ceased, the parallelism of execution can be restored. The deadlock condition can cause a starvation state within the processor, where the processor is waiting for instructions to execute, and the instructions are waiting to be issued.

Techniques for processor management are disclosed. One or more processors are accessed. The one or more processors include one or more logical partitions. A processor from the one or more processors executes one or more instructions out of order. The processor detects a deadlock condition. The deadlock condition prevents the one or more instructions from completing. The deadlock condition occurs in a logical partition within the one or more logical partitions. A parallelism of execution in the logical partition is reduced. The reducing allows the one or more instructions to complete. The reducing is based on one or more control bits. Cessation of the deadlock condition is recognized. The parallelism of execution in the logical partition is restored. The restoring is based on the one or more control bits. The one or more instructions execute on one or more threads running on the processor.

A processor-implemented method for avoiding deadlock is disclosed comprising: accessing one or more processors, wherein the one or more processors include one or more logical partitions; executing, by a processor within the one or more processors, one or more instructions, wherein the processor executes the one or more instructions out of order; detecting, by the processor, a deadlock condition, wherein the deadlock condition prevents the one or more instructions from completing, and wherein the deadlock condition occurs in a logical partition within the one or more logical partitions; reducing, in the logical partition, a parallelism of execution, wherein the reducing allows the one or more instructions to complete, and wherein the reducing is based on one or more control bits; recognizing that the deadlock condition has ceased; and restoring, in the logical partition, the parallelism of execution, wherein the restoring is based on the one or more control bits. In embodiments, the detecting and the recognizing include comparing a first number of instructions issued by the processor to a second number of instructions completed by the processor. In embodiments, the comparing is based on the one or more logical partitions of the processor.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for starvation avoidance in an out-of-order processor.

FIG. 2 is a flow diagram illustrating reducing execution parallelism.

FIG. 3 is an infographic for starvation avoidance in an out-of-order processor.

FIG. 4 is a block diagram illustrating a multicore processor.

FIG. 5 is a block diagram for a pipeline.

FIG. 6 is an infographic for issue queue deadlock detection and reduction of parallelism.

FIG. 7 is an example of issue queues in a processor.

FIG. 8 shows a micro-op example.

FIG. 9 shows a processor pipeline adapted for micro-operations.

FIG. 10 is a system diagram for starvation avoidance in an out-of-order processor

### DETAILED DESCRIPTION

Techniques for starvation avoidance in an out-of-order processor are disclosed. A processor such as a standalone processor, a processor chip, a processor core, a processor on a system-on-a-chip (SoC), and so on can be used to perform various data processing tasks. These data processing tasks can comprise applications for business, government, research, home, entertainment, or another usage. The processor can execute one or more applications, an operating system, and so on substantially simultaneously. The executing can be accomplished using one or more logical partitions associated with the processor. As a result, processes executing in different logical partitions can compete for various shared computational resources such as one or more of a cache, a system memory, input/output (I/O) devices, and so on. The competing applications can get into a condition where each application is waiting for the other to complete an operation such as a memory access. This “deadlock” condition can result from out-of-order execution of instructions associated with each application. In order to get out of the deadlock condition, parallelism of instruction execution in a logical partition can be reduced. The reducing allows the instructions in the deadlocked state to complete. The reducing is based on control bits. When the deadlocked condition has ceased, the parallelism of execution is restored in the logical partition. The restoring parallelism of execution is based on the control bits.

One or more processors are accessed. The one or more processors include one or more logical partitions. The one or more logical partitions comprise a functional unit within the processor. A processor within the one or more processors executes one or more instructions. The processor executes the one or more instructions out of order. The processor detects a deadlock condition. The deadlock condition prevents the one or more instructions from completing, where the deadlock condition occurs in a logical partition within the one or more logical partitions. A parallelism of execution is reduced in the logical partition. The reducing allows the one or more instructions to complete. The reducing includes forcing the one or more instructions to execute in order. The reducing is based on one or more control bits. Cessation of the deadlock condition is recognized. The detecting and the recognizing include comparing a first number of instructions issued by the processor to a second number of instructions completed by the processor. The comparing is based on the one or more logical partitions of the processor. The detecting and the recognizing are based on an estimated number of cycles required for completion of the one or more instructions. The detecting and the recognizing are based on a number of cycles that the one or more instructions has remained in an issue queue within the processor. The parallelism of execution is restored in the logical partition. The restoring is based on the one or more control bits.

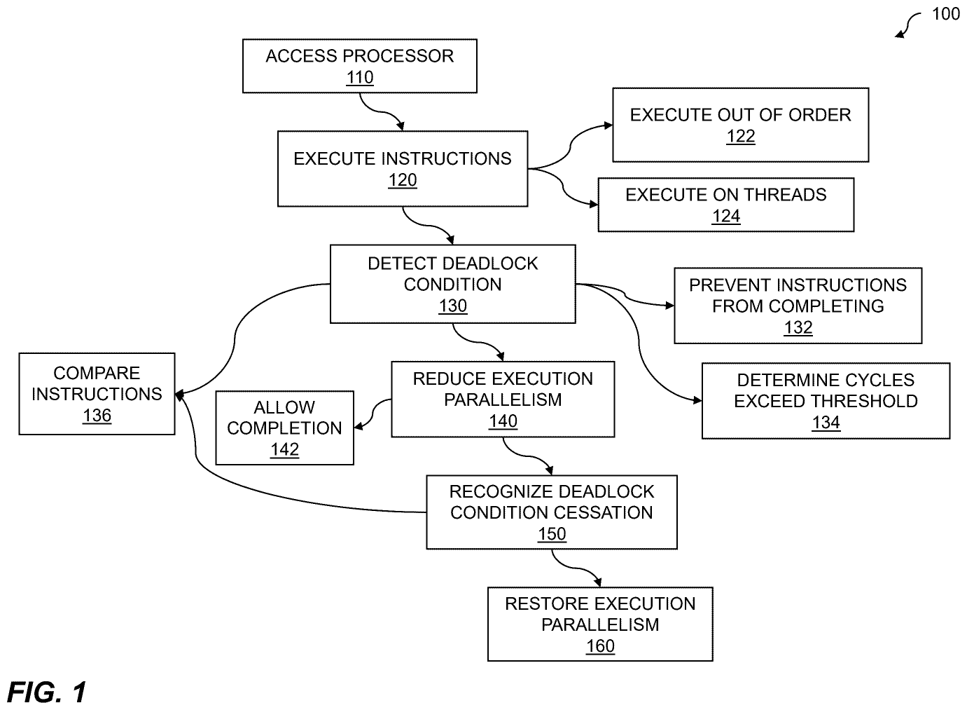

FIG. 1 is a flow diagram for starvation avoidance in an out-of-order processor. Starvation avoidance, whether attributable to a shortage of data or stalled execution of instructions, can be accomplished by detecting a deadlock condition. The deadlock condition can include instructions associated with different applications each attempting to access a shared computational resource. The instructions effectively block each other from being able to access the shared resource. The deadlock condition can be particularly prevalent in processors that include logical partitions. Each logical partition can be used to execute instructions, where out-of-order execution techniques can be used. The particular processor or processors in which logical partitions can be included can be based on a variety of processor architectures. A processor can include a multicore processor such as a RISC-V™ processor. The processor cores can include homogeneous processor cores or heterogeneous processor cores. The cores that are included can have substantially similar capabilities or substantially different capabilities. The one or more processor cores can include further elements. The further elements can include one or more of physical memory protection (PMP) elements, memory management (MMU) elements, level 1 (L1) caches such as instruction caches and data caches, level 2 (L2) caches, and the like. A multicore processor can further include a level 3 (L3) cache, test and debug support such as joint test action group (JTAG) elements, a platform level interrupt controller (PLIC), an advanced core local interrupter (ACLINT), and so on.

The flow 100 includes accessing one or more processors 110. The one or more processors can be based on processors in an integrated circuit or chip, programmable or configurable integrated circuits such as an FPGAs or ASICs, etc. In embodiments, a processor core can include a RISC-V™ processor core. Each processor within the one or more processors can be coupled to one or more elements such as scratchpad memory, register files, a single-level cache or multi-level cache, peripherals, and so on. Each processor of the one or more processor cores has access to memory such as a common memory. The common memory can include on-chip memory, off-chip memory, etc. The one or more processors include one or more logical partitions. Each logical partition can be assigned portions of the processor resources and can act as a virtual processor for executing code, applications, etc. The processor core can further include various components that supplement or enhance the operation of the processor core. The processor core can include an instruction counter, a cycle counter, a control register comprising one or more control bits, and the like.

The flow 100 includes executing 120, by a processor within the one or more processors, one or more instructions. The executing can be accomplished by the processor, by a processor core within the processor, by a logical partition within the processor, and so on. In the flow 100, the processor executes the one or more instructions out of order 122. Out-of-order execution can include the processor executing instructions in an order different from an original order specified in the code. Out-of-order execution enables the processor to take advantage of execution enhancements such as parallelism in the code, stall avoidance, and so on. In the flow 100, the one or more instructions execute on one or more threads 124 running on the processor. A thread can include a portion of a process, where each thread can execute independently. A thread can include a completely separate application running independently from other threads.

The flow 100 includes detecting 130, by the processor, a deadlock condition. A deadlock condition can occur within a processor on which two or more processes are executing. The deadlock condition can occur when the two or more processes share resources such as a single-level or multi-level cache, a shared memory system, and so on. In the flow 100, the deadlock condition prevents the one or more instructions from completing 132. The deadlock condition can occur when each process is preventing the other process or processes from accessing the shared resource. In a usage example, process A and process B “share” a multi-level cache. Here, sharing can include each processor accessing the same multi-level cache. Process A waits for process B to access the cache, but process B sees that process A is trying to access the same cache, so it waits until process A completes. Since both processes are waiting for the other process to complete access, neither process can proceed with execution, thereby creating a deadlock condition. The deadlock condition occurs in a logical partition within the one or more logical partitions. In another example, a deadlock condition can result from two instructions attempting to perform virtual address translation. Both instructions can hit in the same location of the translation lookaside buffer (TLB), effectively overwriting each other's data. A deadlock condition can occur when two or more threads are running on the processor and accessing shared resources. For example, if load and/or store operations in different threads are trying to get through the translation process, i.e., multiple threads fighting for the TLB, then a deadlock condition can occur. A deadlock condition can also occur when an instruction is executed through the use of one or more micro-operations. Since interrupts must occur on instruction boundaries, the micro-operations which comprise the instruction must execute so that the interrupt can be taken. However, if a deadlock occurs due to shared resources, or another issue, the processor may not be able to take interrupts until the deadlock is cleared. A deadlock condition can be created in many other ways on the processor.

The flow 100 further includes comparing instructions 136 to detect a deadlock condition and to recognize cessation of the deadlock condition. A first number of instructions representing the number of instructions issued by a processor can be compared to a second number of instructions representing the number of instructions completed by the processor. When the comparison reveals that the first number is greater than the second number by a certain amount or threshold 134, the presence or cessation of a deadlock condition can be inferred. The amount or threshold of the comparing can be set based on workload type, performance metrics, environmental conditions, and so on. The comparing can be accomplished based on what logical partitions are being run on a processor. The logical partitions can include various functions, such as function units within the processor. In embodiments, the detecting and the recognizing include comparing a first number of instructions issued by the processor to a second number of instructions completed by the processor. In embodiments, the comparing is based on the one or more logical partitions of the processor. In embodiments, the one or more logical partitions comprise a functional unit within the processor.

The flow 100 includes reducing 140, in the logical partition, a parallelism of execution. The reducing parallelism of execution can include executing instructions associated with one process or another, executing instructions in order, and so on. In the flow 100, the reducing allows the one or more instructions to complete 142. The reducing can eliminate a hold, lock, or other indication that execution of an instruction needs to be held, suspended, delayed, etc. The reducing can be based on one or more control bits. The control bits can include one or more bits associated with instruction execution such as hold, suspend, proceed, and so on. The reducing can include forcing the one or more instructions to execute in order. The executing in order can include executing the code without taking advantage of one or more instructions that might be executed in parallel to reduce execution time. Setting the one or more control bits can be based on the deadlock detection. The one or more control bits can be used to control execution of one or more instructions. The control bits can correspond to the one or more logical partitions of the processor, to threads running on the processor, and so on. The control bits enable a fine granularity of control of the deadlock cessation strategies. The control bits can enable or disable execution by a logical partition, a command to suspend execution, etc. The control bits can control execution by enabling or disabling access, switching from out-of-order execution to in-order (normal) execution, and so on. The control bits can correspond to a functional unit within the processor.

The flow 100 includes recognizing 150 that the deadlock condition has ceased. The deadlock condition can cease when one or more mitigation techniques, such as the various techniques associated with reducing execution parallelism, were successful in resolving the deadlock condition. As similarly described above regarding the detecting, the recognizing can also include comparing a first number of instructions issued by the processor to a second number of instructions completed by the processor. In a usage example, a first number of instructions can include a number of instructions, generated by a complier, that are issued by the processor for execution. The issued instructions can be executed in an expected number of cycles. If the expected number of cycles has occurred, and no result is detected or received, then an execution problem can be detected. If the expected result is detected or received, the no deadlock occurred, or the deadlock condition was resolved. The expected result can be the same or a different result than was used in the detecting. In embodiments, the comparing can be based on the one or more logical partitions of the processor. The one or more logical partitions can include substantially similar partitions. The partitions can execute one or more instructions. In embodiments, the one or more logical partitions can include a functional unit within the processor. A functional unit can include a processor, a controller, a memory management unit (MMU), and arithmetic logic unit (ALU), and so on.

In embodiments, the detecting and the recognizing can be based on an estimated number of cycles required for completion of the one or more instructions. The estimated number of cycles can be determined by the processor, a logical partition, and so on. The estimated number of cycles can be based on information provided by a compiler. In embodiments, the detecting and the recognizing can be based on a number of cycles that the one or more instructions have remained in an issue queue within the processor. In a usage example, an instruction is placed in an issue queue within the processor. Under normal operation, a result generated by the instruction can be expected to be returned based on an estimated number of cycles. If no result is obtained, then the processor can look to see whether the instruction within the issue queue was issued. The estimated number can be a threshold number. The flow 100 includes restoring 160, in the logical partition, the parallelism of execution, wherein the restoring is based on the one or more control bits. Having recognized that the deadlock condition has ceased, the execution parallelism can be restored. How the execution parallelism is restored can be based on what actions were taken to reduce the execution parallelism. The steps to reduction were based on the control bits.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

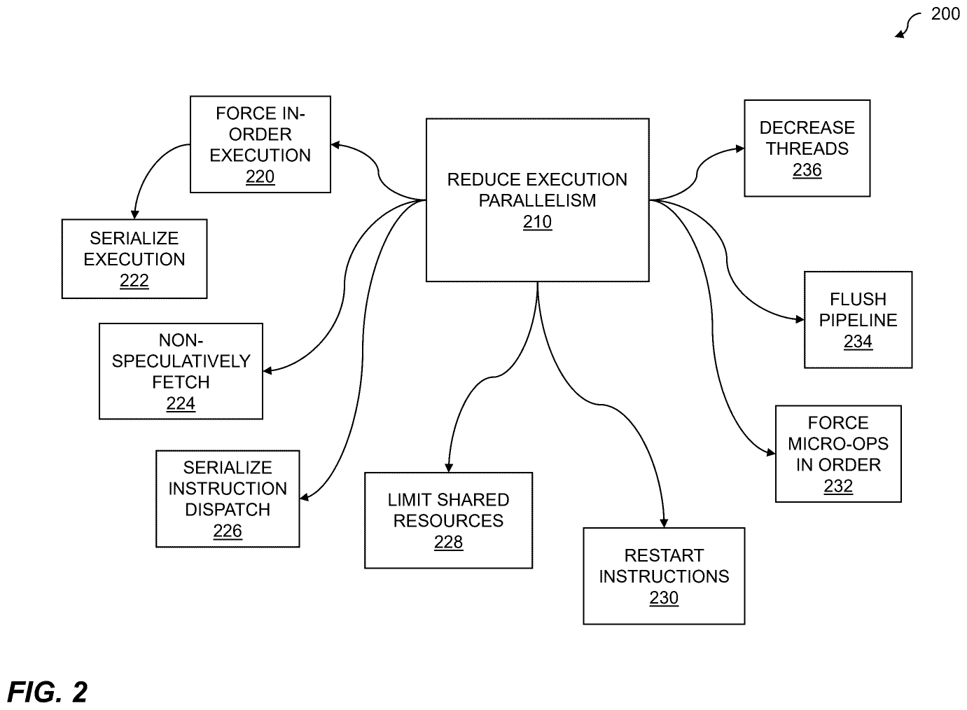

FIG. 2 is a flow diagram illustrating the reducing of execution parallelism. Execution parallelism is often highly utilized for increasing performance in one or more processors. However, parallelism can lead to a processor deadlock condition. Reducing execution parallelism can enable starvation avoidance in an out-of-order processor. One or more processors are accessed. The one or more processors include one or more logical partitions. A processor from the one or more processors executes one or more instructions out of order. The processor detects a deadlock condition. The deadlock condition prevents the one or more instructions from completing. The deadlock condition occurs in a logical partition within the one or more logical partitions. A parallelism of execution in the logical partition is reduced. The reducing allows the one or more instructions to complete. The reducing is based on one or more control bits. Cessation of the deadlock condition is recognized. The parallelism of execution in the logical partition is restored. The restoring is based on the one or more control bits.

The flow 200 illustrates reducing execution parallelism 210. A number of techniques can be used to reduce execution parallelism and thereby eliminate a deadlock condition. The flow 200 includes forcing in-order execution 220. As discussed above and throughout, while out-of-order execution can increase processor performance, it can also lead to processor deadlock. The deadlock condition can be related to issue queues, dispatching mechanisms, one or more execution pipelines, renaming logic, reorder buffers, and so on. Forcing in-order execution of one or more instructions can lead to a cessation of deadlock. The one or more instructions forced in order can affect a thread, a process, a function unit, etc. The forcing can be determined by one or more control bits. The forcing can comprise serializing the execution 222 of one or more instructions. Serializing the execution can resolve a deadlock condition, although the normal super-scalar operation is temporarily suspended. The flow 200 includes non-speculatively fetching instructions 224. Out-of-order processors can include both speculative execution and also speculative fetching of instructions. A speculatively fetched instruction that causes a deadlock can be mitigated by preventing such fetching. For example, an instruction that occurs after a branch can be fetched after the path is known to be taken or not taken. While lowering performance, this approach can be effective in limiting pipeline complexity and eliminating the need to flush instructions from processor pipelines that were mispredicted. This reduction in complexity can allow instruction flow to continue once deadlocked. The flow 200 can also include serializing the instruction dispatch 226. Serializing instruction dispatch can lead to cessation of a deadlock condition. In embodiments, the reducing includes forcing the one or more instructions to execute in order. In embodiments, the reducing includes a serialization of in-order operations. In embodiments, the reducing includes non-speculatively fetching instructions. In embodiments, the reducing includes serializing an instruction dispatch.

An instruction within the one or more instructions can include one or more micro-operations. The one or more micro-operations can be executed atomically. A micro-operation can include a memory access, an arithmetic operation, a logical operation, etc. In the flow 200, the reducing includes forcing the one or more micro-operations to execute in order 232. One or more micro-operations can be associated with each instruction or operation. Executing micro-operations in order forces the micro-operations to proceed, thereby completing execution of the operation with which the micro-operations are associated. In the flow 200, the reducing includes restarting the one or more instructions 230. Restarting the instructions can enable an instruction to wait while another instruction proceeds with execution. In the flow 200, the reducing includes decreasing a number of threads 236 running on the processor. One or more threads can be suspended, halted, etc. to reduce the number of executing threads. The reduced number of executing threads can proceed with execution. In the flow 200, the reducing includes limiting one or more shared resources 228, wherein the one or more shared resources are utilized by at least two of the one or more instructions. The reducing shared resources can be accomplished by assigning different resources to instructions, assigning different translation lookaside buffers to different instructions or processing, and the like. In the flow 200, the reducing includes flushing the pipeline 234. A pipeline flush can release processor resources (such as queues, buffers, etc.), which had become unresponsive due to the deadlock condition. To continue execution, one or more instructions that failed to execute can be retried using one or more of the reducing strategies described above. The pipeline flush can include a portion of a pipeline, the entire pipeline, a single thread, multiple threads, and so on. The flush can occur on an instruction boundary. The flushing will generally have to wait on any pending load or store operation to complete before the flushing is performed. In embodiments, an instruction within the one or more instructions comprises one or more micro-operations, wherein the one or more micro-operations are executed atomically. In embodiments, the reducing includes forcing the one or more micro-operations to execute in order. In embodiments, the reducing includes a flush of a pipeline within the one or more processors. In embodiments, the flush occurs on an instruction boundary. In embodiments, the flush occurs on one or more threads executing on the one or more processors.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on

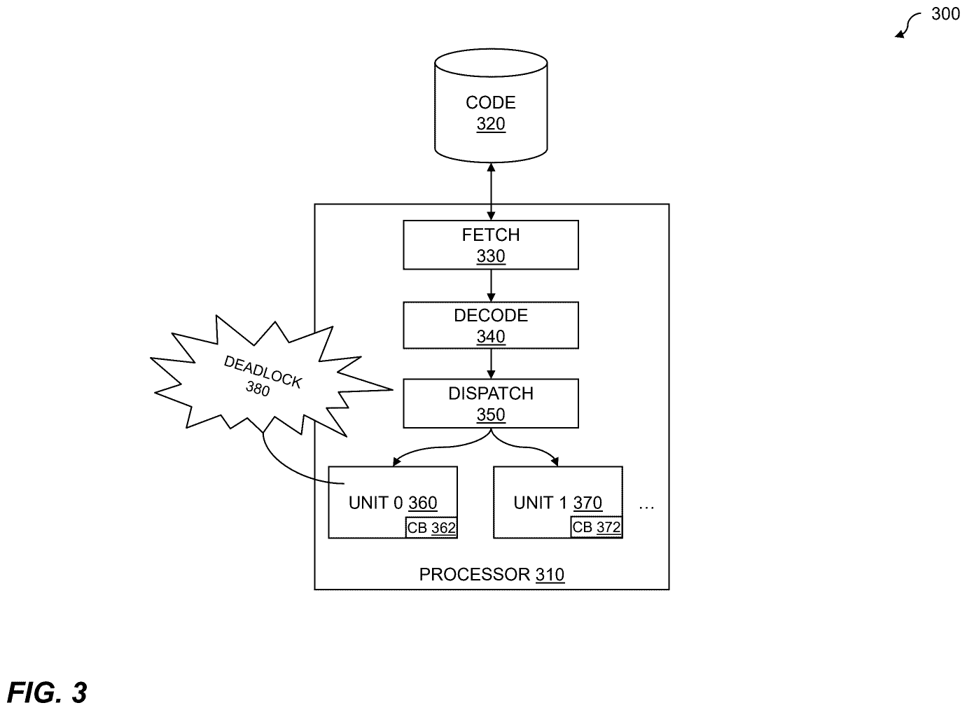

FIG. 3 is an infographic for starvation avoidance in an out-of-order processor. Starvation avoidance in an out-of-order processor is disclosed. One or more processors are accessed. The one or more processors include one or more logical partitions. A processor from the one or more processors executes one or more instructions out of order. The processor detects a deadlock condition. The deadlock condition prevents the one or more instructions from completing. The deadlock condition occurs in a logical partition within the one or more logical partitions. A parallelism of execution in the logical partition is reduced. The reducing allows the one or more instructions to complete. The reducing is based on one or more control bits. Cessation of the deadlock condition is recognized. The parallelism of execution in the logical partition is restored. The restoring is based on the one or more control bits.

The infographic 300 includes a processor 310 running code 320. The processor can comprise a processor, a processor core, a network of processors, a RISC-V™ processor, and so on. The code can represent a single program, multiple programs, related programs, unrelated programs, common users, disparate users, cloud workloads, artificial intelligence workloads, etc. The code can be executed in a processor pipeline that includes various functional units such as a fetch unit 330, a decode unit 340, and a dispatch unit 350. The fetch unit 330, the decode unit 340, and the dispatch unit 350 can prepare an instruction stream for execution by one or more execution units, such as execution unit 0 360, with control bits 362, and execution unit 1 370, with control bits 372. Additional execution units (not shown) are also possible. The control bits can determine which deadlock condition mitigation techniques will be employed for a given instruction, operation, logical partition, thread, and so on. The techniques can be implemented without user intervention. Instructions can be dispatched for execution to either or both execution units 0 and 1, which can result in a deadlock condition between or among the execution units and other shared resources, such as cache, memory, TLBs, functional units, and so on. The infographic 300 depicts just such a deadlock condition 380 that is preventing unit 0 360 from executing an instruction from dispatch unit 350. In certain circumstances, the deadlock condition can be severe, preventing the processor from servicing interrupts and/or preventing a user from manually freeing up resources by halting program execution. As described above and throughout, reducing execution parallelism can enable cessation of the deadlock condition and its associated starvation.

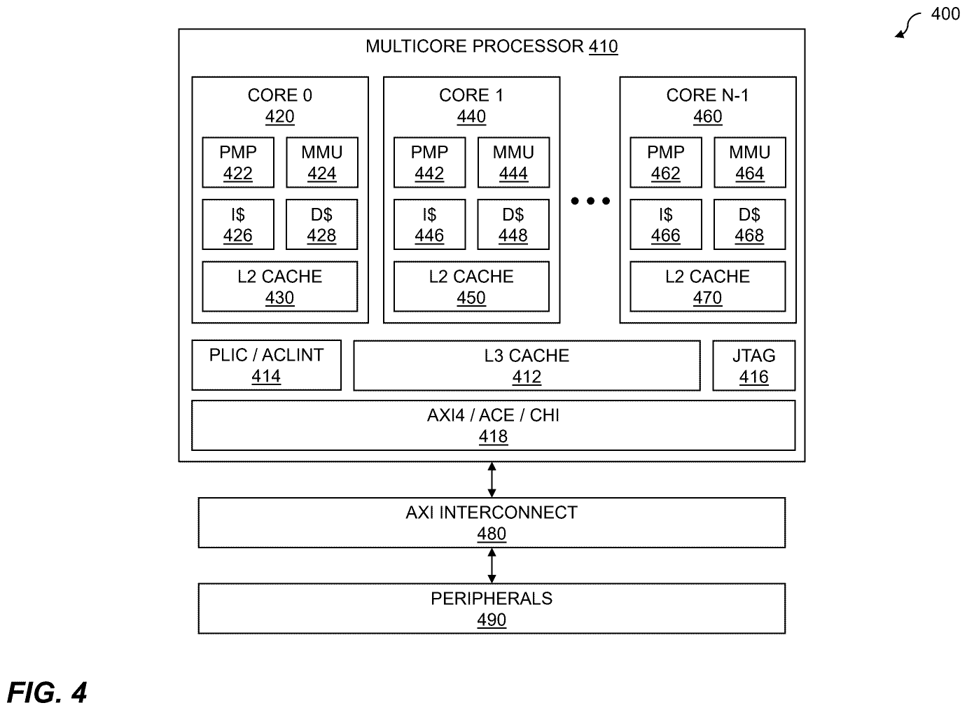

FIG. 4 is a block diagram illustrating a multicore processor. The processor can include a multi-core processor, where two or more processor cores can be included. The processor, such as a RISC-V™ processor, can include a variety of elements. The elements can include processor cores, one or more caches, memory protection and management units, local storage, and so on. The elements of the multicore processor can further include one or more of a private cache, a test interface such as a joint test action group (JTAG) test interface, one or more interfaces to a network such as a network-on-chip, shared memory, peripherals, and the like. Starvation avoidance in an out-of-order, multicore processor is disclosed. One or more processors are accessed. The one or more processors include one or more logical partitions. A processor from the one or more processors executes one or more instructions out of order. The processor detects a deadlock condition. The deadlock condition prevents the one or more instructions from completing. The deadlock condition occurs in a logical partition within the one or more logical partitions. A parallelism of execution in the logical partition is reduced. The reducing allows the one or more instructions to complete. The reducing is based on one or more control bits. Cessation of the deadlock condition is recognized. The parallelism of execution in the logical partition is restored. The restoring is based on the one or more control bits.

The block diagram 400 includes a multicore processor 410. The multicore processor can comprise two or more processors, where the two or more processors can include homogeneous processors, heterogeneous processors, etc. In the block diagram, the multicore processor can include N processor cores such as core 0 420, core 1 440, core N-1 460, and so on. Each processor can comprise one or more elements. In embodiments, each core, including cores 0 through core N-1, can include a physical memory protection (PMP) element, such as PMP 422 for core 0; PMP 442 for core 1, and PMP 462 for core N-1. In a processor architecture such as the RISC-V™ architecture, PMP can enable processor firmware to specify one or more regions of physical memory such as cache memory of the shared memory, and to control permissions to access the regions of physical memory. The cores can include a memory management unit (MMU) such as MMU 424 for core 0, MMU 444 for core 1, and MMU 464 for core N-1. The memory management units can translate virtual addresses used by software running on the cores to physical memory addresses with caches, the shared memory system, etc.

The processor cores associated with the multicore processor 410 can include caches such as instruction caches and data caches. The caches, which can comprise level 1 (L1) caches, can include an amount of storage such as 16 KB, 32 KB, and so on. The caches can include an instruction cache I$ 426 and a data cache D$ 428 associated with core 0; an instruction cache I$ 446 and a data cache D$ 448 associated with core 1; and an instruction cache I$ 466 and a data cache D$ 468 associated with core N-1. In addition to the level 1 instruction and data caches, each core can include a level 2 (L2) cache. The level 2 caches can include an L2 cache 430 associated with core 0; an L2 cache 450 associated with core 1; and an L2 cache 470 associated with core N-1. The cores associated with the multicore processor 410 can include further components or elements. The further elements can include a level 3 (L3) cache 412. The level 3 cache, which can be larger than the level 1 instruction and data caches, and the level 2 caches associated with each core, can be shared among all of the cores. The further elements can be shared among the cores. In embodiments, the further elements can include a platform level interrupt controller (PLIC) 414. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 416. The JTAG can provide boundaries within the cores of the multicore processor. The JTAG can enable fault information to a high precision. The high-precision fault information can be critical to rapid fault detection and repair.

The multicore processor 410 can include one or more interface elements 418. The interface elements can support standard processor interfaces such as an Advanced extensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. In the block diagram 400, the interface elements can be coupled to an interconnect. The interconnect can include a bus, a network, and so on. The interconnect can include an AXI™ interconnect 480. In embodiments, the network can include network-on-chip functionality. The AXI™ interconnect can be used to connect memory-mapped “master” or boss devices to one or more “slave” or worker devices. In the block diagram 400, the AXI™ interconnect can provide connectivity between the multicore processor 410 and one or more peripherals 490. The one or more peripherals can include storage devices, networking devices, and so on. The peripherals can enable communication using the AXI™ interconnect by supporting standards such as AMBMA™ version 4, among other standards.

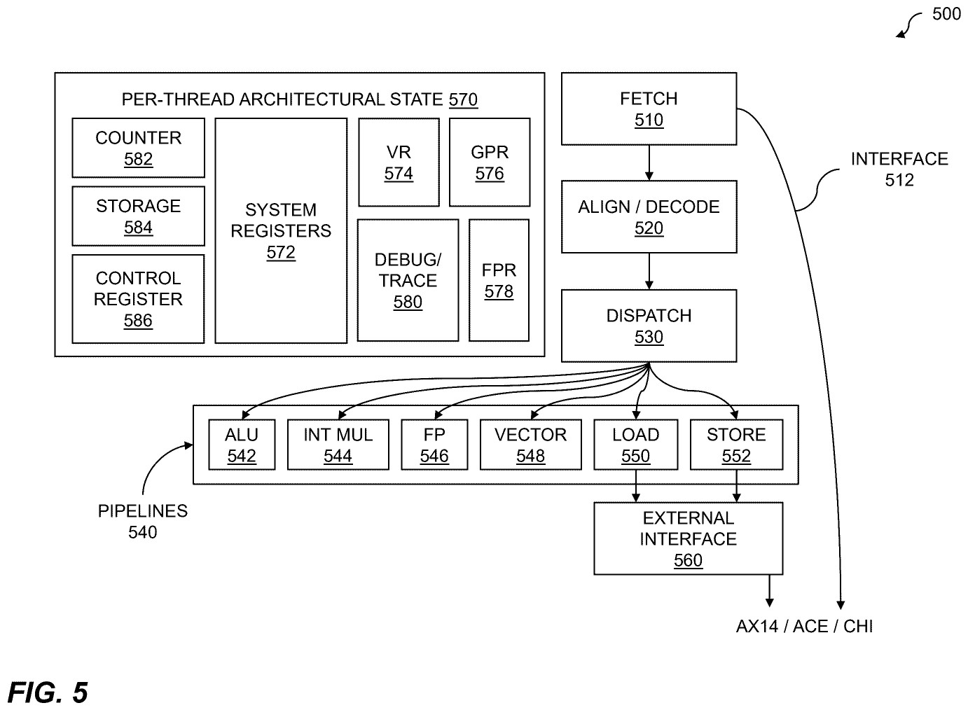

FIG. 5 is a block diagram for a pipeline. The use of one or more pipelines associated with a processor architecture can greatly enhance processing throughput. The processing throughput can be increased because multiple operations can be executed in parallel. Starvation avoidance in an out-of-order processor with pipelines is disclosed. One or more processors are accessed. The one or more processors include one or more logical partitions. A processor from the one or more processors executes one or more instructions out of order. The processor detects a deadlock condition. The deadlock condition prevents the one or more instructions from completing. The deadlock condition occurs in a logical partition within the one or more logical partitions. A parallelism of execution in the logical partition is reduced. The reducing allows the one or more instructions to complete. The reducing is based on one or more control bits. Cessation of the deadlock condition is recognized. The parallelism of execution in the logical partition is restored. The restoring is based on the one or more control bits.

The block diagram 500 shows a block diagram of a pipeline such as a core pipeline. The blocks within the block diagram can be configurable in order to provide varying processing levels. The varying processing levels can be based on processing speed, bit lengths, and so on. The block diagram 500 can include a fetch block 510. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 512. The interface can include a standard interface such as one or more industry standard interfaces. The interfaces can include an Advanced eXtensible Interface (AXI™), an ARM™ Advanced eXtensible Interface (AXI™) Coherence Extensions (ACE™) interface, an Advanced Microcontroller Bus Architecture (AMBA™) Coherence Hub Interface (CHI™), etc.

The block diagram 500 includes an align and decode block 520. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 500 can include a dispatch block 530. The dispatch block can receive decoded instruction packets from the align and decode block. The decoded instruction packets can be used to control a pipeline 540, where the pipeline can include an in-order pipeline, an out-of-order (OoO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 542, integer multiplier pipelines 544, floating-point unit (FPU) pipelines 546, vector unit (VU) pipelines 548, and so on. The dispatch unit can further dispatch instructions to pipelines that can include load pipelines 550, and store pipelines 552. The load pipelines and the store pipelines can access storage such as the common memory using an external interface 560. The external interface can be based on one or more interface standards such as the Advanced eXtensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, one or more processor cores can be configured to support multi-threading. The system block diagram can include a per-thread architectural state block 570. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 572. The system registers can be associated with individual processors or processor cores, a system comprising multiple processors or processor cores, and so on. The system registers can include exception and interrupt components, counters, etc. The per-thread architectural state can include further registers such as vector registers (VR) 574, general purpose registers (GPR) 576, and floating-point registers (FPR) 578. These registers can be used for vector operations, general purpose (e.g., integer) operations, and floating-point operations, respectively. The per-thread architectural state can include a debug and trace block 580. The debug and trace block can enable debug and trace operations to support code development, troubleshooting, and so on. In embodiments, an external debugger can communicate with a processor through a debugging interface such as a joint test action group (JTAG) interface. The per-thread architectural state can include a performance counter 582. The performance counter can be used to sample program or code execution, to generate a performance profile, and so on. The performance profile can be based on saving repeated program states. The program states can be sampled on a periodic basis and saved for analysis. In embodiments, the performance profile can be generated by the external profiling agent. The per-thread architecture can include a performance counter storage area 584. The program states, which can be sampled on a periodic basis, can be saved to the storage area, etc. The saving can be based on a counter event in the performance counter. The per-thread architecture can include a performance counter control register 586. In embodiments, the performance counter and the performance counter control register are loaded by the external profiling agent. The loading of the performance counter and the performance counter control register can be based on a particular event. The particular event can be associated with the processor core and can include a counter event, an interrupt or exception, and so on. In embodiments, the particular event can include human direction such as requesting a program profile for a program or code that is executing, analyzing an anomalous event, etc.

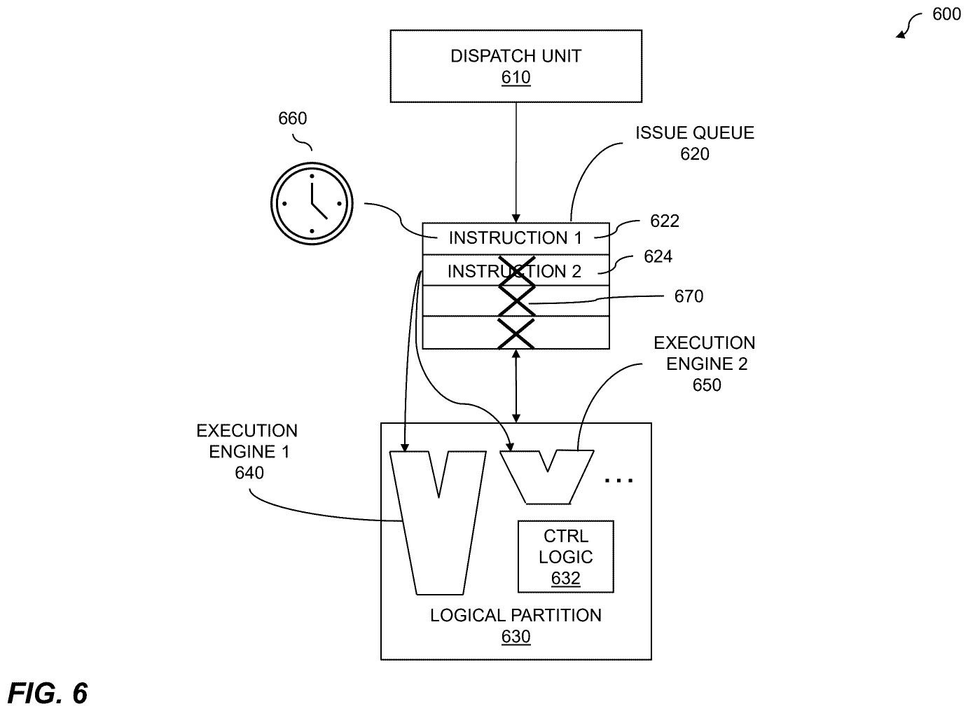

FIG. 6 is an infographic for issue queue deadlock detection and reduction of parallelism. Issue queue deadlock detection and reduction of parallelism can enable starvation avoidance in an out-of-order processor. One or more processors are accessed. The one or more processors include one or more logical partitions. A processor from the one or more processors executes one or more instructions out of order. The processor detects a deadlock condition. The deadlock condition prevents the one or more instructions from completing. The deadlock condition occurs in a logical partition within the one or more logical partitions. A parallelism of execution in the logical partition is reduced. The reducing allows the one or more instructions to complete. The reducing is based on one or more control bits. Cessation of the deadlock condition is recognized. The parallelism of execution in the logical partition is restored. The restoring is based on the one or more control bits.

The infographic 600 is an example processor portion that shows a dispatch unit 610, an issue queue 620, and a logical partition 630. The logical partition can comprise one or more execution engines, such as execution engine 1 640 and execution engine 2 650. Additional execution engines can also comprise the logical partition 630. Other logical partitions can also exist in a multicore processor. Instructions that are dispatched out of dispatch unit 610 into issue queue 620 can execute out of order, and as discussed above and throughout, they can compete for the same resource, data, bus, execution engine, etc. and thereby cause a processor deadlock condition. The mitigation strategy for issue queue congestion illustrated in infographic 600 can remove the deadlock condition in some cases. To wit, note that instruction 1 622 in the issue queue is waiting for promotion to an execution engine. However, a deadlock condition has occurred, and as a result, instruction 1 has not been moved from the issue queue. Using a facility 660 to determine how long instruction 1 has been waiting for issuance, such as a clock cycle counter, a threshold number of cycles can be determined to have been exceeded. (Other facility types for determining issue queue entry aging are possible, such as real time clock passage.) Reaching the threshold number can trigger the flushing of other instructions in the issue queue such as instruction 2 624. Further, the instruction queue can be restricted such that no new instructions, as designated by the large X's 670, are queued until the deadlock condition is corrected and instruction 1 is sent to an execution unit for processing. The instructions that were flushed can be retried once the deadlock condition has been resolved. If the deadlock condition still persists, other mitigation measures, as described herein, can be attempted. In embodiments, the detecting and the recognizing can be based on a number of cycles that the one or more instructions have remained in an issue queue within the processor.

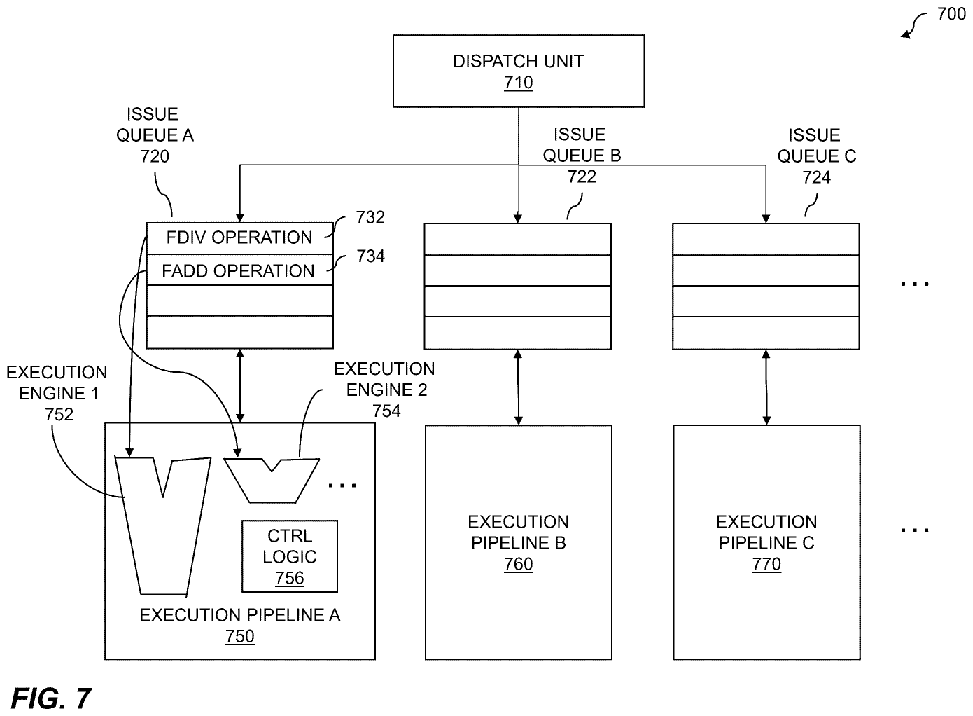

FIG. 7 is an example of issue queues in a processor. Issue queues are an integral part of processors and must be properly handled to support starvation avoidance in an out-of-order processor. One or more processors are accessed. The one or more processors include one or more logical partitions. A processor from the one or more processors executes one or more instructions out of order. The processor detects a deadlock condition. The deadlock condition prevents the one or more instructions from completing. The deadlock condition occurs in a logical partition within the one or more logical partitions. A parallelism of execution in the logical partition is reduced. The reducing allows the one or more instructions to complete. The reducing is based on one or more control bits. Cessation of the deadlock condition is recognized. The parallelism of execution in the logical partition is restored. The restoring is based on the one or more control bits.

The example 700 includes a dispatch unit 710. The dispatch unit 710 receives instructions that were fetched and decoded by the processor core, and sends the instructions to one or more issue queues. In example 700, three issue queues are shown, indicated as issue queue A 720, issue queue B 722, and issue queue C 724. While three issue queues are shown in example 700, other embodiments may have more or fewer issue queues. Each issue queue has a corresponding depth, indicating the number of entries in the queue. In one or more embodiments, the depth is a fixed value. As shown in FIG. 7, there are four entries in each issue queue, indicating a depth of four. In practice, the depth of each queue can be a different value. In one or more embodiments, the depth of each queue is a value ranging from 8 to 256. In embodiments, each issue queue has the same depth. In other embodiments, the issue queues have different depths. As an example, issue queue A 720 can have a depth of 32, issue queue B 722 can have a depth of 64, and issue queue C 724 can have a depth of 128. In embodiments, each issue queue corresponds to a different category of instruction. As an example, issue queue A 720 can correspond to floating-point instructions, issue queue B 722 can correspond to integer instructions, and issue queue C 724 can correspond to vector instructions. Each issue queue may contain one or more fixed latency instructions and/or one or more variable latency instructions. In embodiments, each execution pipeline in the one or more additional execution pipelines includes a unique issue queue. In embodiments, each issue queue is coupled to a common write-back pipeline to provide a mechanism for completing all operations processed by the issue queue.

Referring now to issue queue A 720, two instructions are shown. Instruction 732 represents a floating-point division (FDIV) operation, which can be a variable latency operation. Instruction 734 represents a floating-point add (FADD) operation, which can be a fixed latency operation. The FADD operation can depend on the results of the FDIV operation. Each issue queue is coupled to a corresponding execution pipeline. Issue queue A 720 is coupled to execution pipeline A 750. Similarly, issue queue B 722 is coupled to execution pipeline B 760, and issue queue C 724 is coupled to execution pipeline C 770. Each of the execution pipelines can include one or more execution engines that receive operations to be executed by the related issue queue. Referring now to execution pipeline A 750, additional detail is shown, including instruction queue control logic 756, execution engine 1 752, and execution engine 2 754. One or more execution engines can be designated to execute variable latency operations, such as execution engine 1 752 in example 700. One or more execution engines can be designated to execute fixed latency operations, such as execution engine 2 754 in example 700. In embodiments, instructions are picked from issue queue A 720, and the picked instructions are routed to the appropriate execution engine. In one or more embodiments, the criteria for routing to a given execution engine can be based on an instruction op code. In one or more embodiments, an operation, such as the FDIV operation 732, is designated as variable latency instruction and thus will be issued by the issue queue to execution engine 1 752. Other instruction types can be designated as fixed latency instructions, such as the FADD operation 734, which has been assigned to execution engine 2 754 within execution pipeline A 750. In one or more embodiments, instructions such as floating-point division instructions, floating-point square root instructions, logarithmic instructions, trigonometric function instructions, and exponent instructions are deemed to be variable latency instructions, and can be dispatched to the variable latency execution engine 1 752. Similarly, instructions such as floating-point addition and subtraction instructions can be deemed to be fixed latency instructions, and are accordingly dispatched to the fixed latency execution engine 2 754.

Instructions executing in execution engine 2 754 are fixed latency operations, and thus, are deterministic in terms of execution time. Conversely, instructions executing in execution engine 1 752 are variable latency operations, and thus, are nondeterministic regarding execution time. In one or more embodiments, once a variable latency execution instruction finishes execution, the execution engine 1 752 can notify the control logic 756. The control logic 756 can then make a request to the issue queue to complete the variable latency operation. In response, issue queue A 720 can examine the issue queue entries, pipeline stages within execution engine 2, and so on. The issue queue can then determine when a slot (bubble) is available for the result from the variable latency execution engine 1 752 to be inserted into the common write-back pipeline. Once an upcoming slot is available, issue queue A can grant the request and the result from the variable latency execution engine 1 752 can be provided to the common write-back pipeline. In some embodiments, issue queue A examines pipeline stages and actively creates a slot. This can include delaying one or more instructions destined for the fixed latency execution engine 2 754, or delaying the completion of a variable latency instruction in execution engine 1 752.

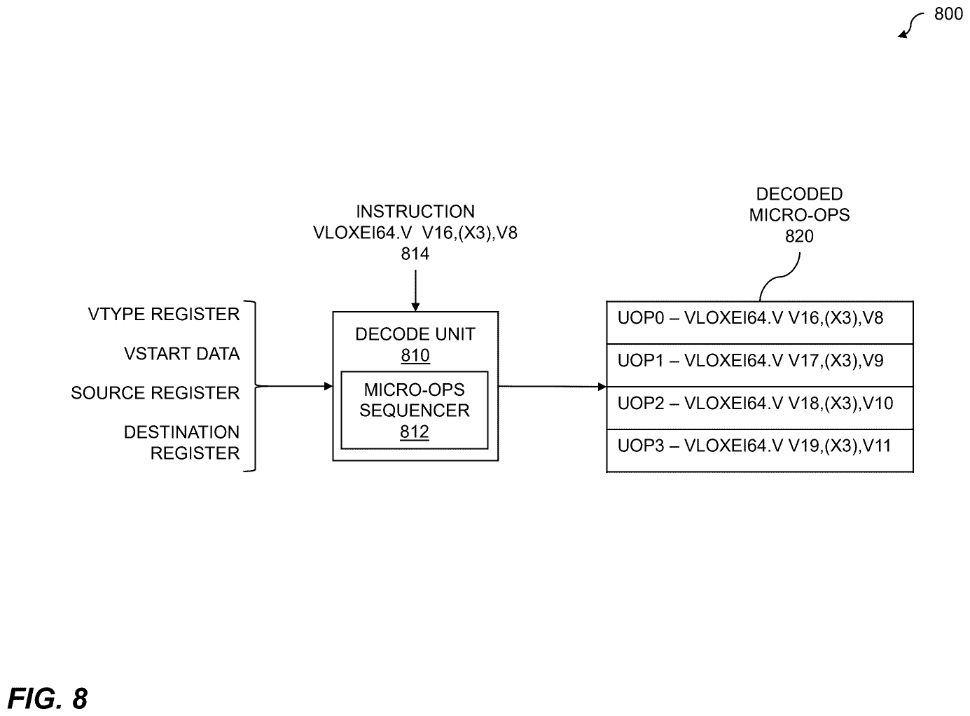

FIG. 8 shows a micro-op example. Recall that a decode stage associated with a processor core can be used to split an operation such as a vector operation into a series of micro-operations. The micro-operations can include load operations and store operations associated with a vector operation. The micro-operations can be executed, where the execution can be accomplished on a processor core. The execution of the micro-operations can be interrupted due to an operation exception. The operation exception can be processed, and execution of the micro-operations can be completed. The micro-operations need to be included in starvation avoidance in an out-of-order processor. One or more processors are accessed. The one or more processors include one or more logical partitions. A processor from the one or more processors executes one or more instructions out of order. The processor detects a deadlock condition. The deadlock condition prevents the one or more instructions from completing. The deadlock condition occurs in a logical partition within the one or more logical partitions. A parallelism of execution in the logical partition is reduced. The reducing allows the one or more instructions to complete. The reducing is based on one or more control bits. Cessation of the deadlock condition is recognized. The parallelism of execution in the logical partition is restored. The restoring is based on the one or more control bits.

The example 800 shows efficient decoding of a vector indexed load/store instruction. The decoding is accomplished using micro-operation sequencing. A decode unit 810 can be associated with a processor core (not shown). The decode unit can include a micro-operation sequencer 812. In embodiments, the micro-operation sequencer can assign the series of micro-operations, based on a type of the vector operation. A non-segmented vector indexed load operation is shown 814: vloxei64.v v16,(x3),v8. LMU-4, VSEW=64 bit (from a VTYPE register), EEW=64 bits (from the opcode), VLEN=128 bits, and v1=8. In the example, LMUL is set to 4, VSEW=64 bit by executing a VSET instruction prior to above instruction. During the decode of “vloxei64.v v16,(x3),v8”, a micro-operation sequencer logic block will split the single instruction into four micro-operations 820. The micro-operation sequencer block 812 is implemented as finite state machine, which takes inputs such as VTYPE register info (vsew, lmul), VSTART data, a source register (vrs2) and destination (vd) register. The micro-operation sequencer logic can ensure that it increments source (vrs2) and destination (vd) as per requirement of the processor vector spec when it breaks the instruction into four micro-operations. The processor vector spec can include a RISC-V vector spec.

An exception can occur. In the example, a page fault exception is reported during micro-operation uop3 execution. Once the LSU unit reports the exception with vstart value=6 to the decoder, the vstart value will be written to the start architectural register inside the decoder block during the retirement of uop2. After the exception is triggered, the program counter (PC) will start fetching from the exception handler. After servicing the exception, the PC should return to same instruction vloxei64.v v16,(x3),v8 to complete the entire load operation. Instead of starting the execution from micro-operation uop0, the decode logic will skip micro-operations uop0, uop1 and uop2, and only issue micro-operation uop3 as per the vstart architectural value. Based on the vector configurations, a particular instruction can be broken into a number of micro-operations up to eight micro-operations. The above scheme can provide significant performance and power advantages during a variety of exception scenarios.

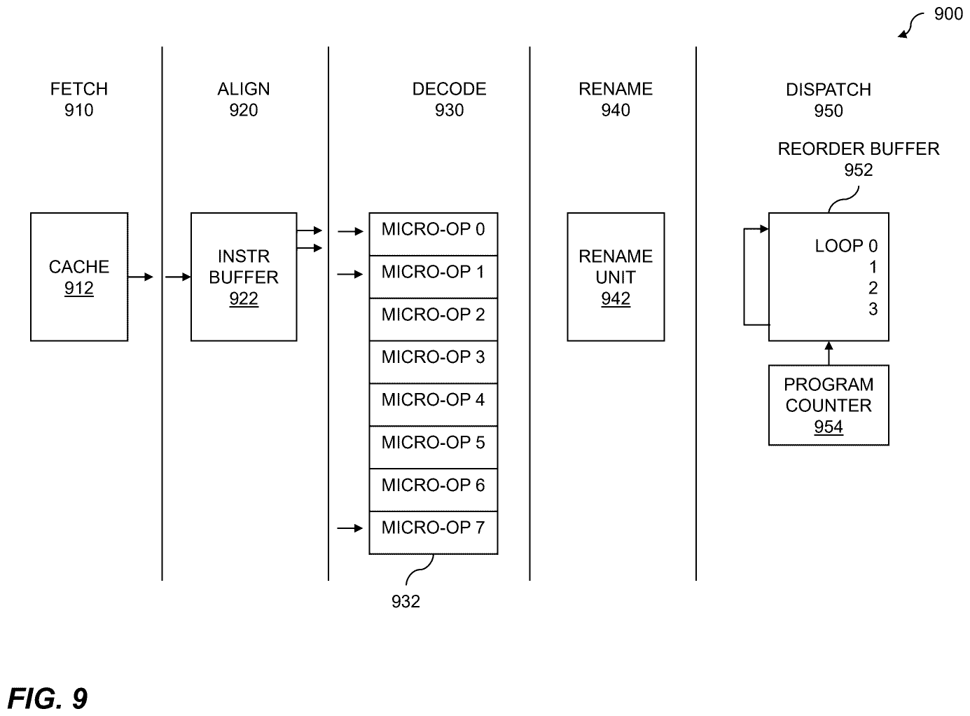

FIG. 9 shows a processor pipeline adapted for vector operations. A pipeline can be associated with a processor core. The processor core can be based on a variety of design approaches and processor architectures such as a RISC-V™ processor. The pipeline can be adapted for vector operations. The vector operations can be split into micro-operations in order to handle exceptions such as runtime exceptions. The pipeline described herein can support starvation avoidance in an out-of-order processor. One or more processors are accessed. The one or more processors include one or more logical partitions. A processor from the one or more processors executes one or more instructions out of order. The processor detects a deadlock condition. The deadlock condition prevents the one or more instructions from completing. The deadlock condition occurs in a logical partition within the one or more logical partitions. A parallelism of execution in the logical partition is reduced. The reducing allows the one or more instructions to complete. The reducing is based on one or more control bits. Cessation of the deadlock condition is recognized. The parallelism of execution in the logical partition is restored. The restoring is based on the one or more control bits.

A pipeline adapted for vector operations is shown. The pipeline comprises a plurality of stages that can, when the pipe is filled, be executing substantially simultaneously. The use of the pipeline can significantly enhance processing of operations such as vector operations. The pipeline 900 can include a fetch element 910. The fetch element can obtain data from one or more storage elements. The storage elements can include a cache 912. The cache can include a local cache, a shared, cache, and so on. The cache can include a multilevel cache technique, where the multiple levels of the cache can include one or more of a level 1 (L1) cache, a level 2 (L2) cache, a level 3 (L3) cache, and the like. The pipeline 900 can include an alignment element 920. The alignment register can align a vector operation to a boundary or edge such as a byte or word edge. The aligning enables decoding the vector operation (discussed below). The alignment element can include instruction buffer 922. The instruction buffer can contain one or more aligned vector operations. The aligning can be based on one or more parameters associated with the vector operation. The one or more parameters can include an element width (ELEN), a vector register width (VLEN), a selected element width (SEW), a vector register group multiplier (LMUL), maximum operable elements (VLMAX), a vector length (VL), a starting element (VSTART), etc. The pipeline can include a decode element 930. The decode element can decode an operation such as a vector operation into a series of micro-operations. A plurality of vector operations is shown 932. While eight micro-operations are shown, such as micro-op 0, micro-op 1, micro-op 2, micro-op 3, micro-op 4, micro-op 5, micro-op 6, and micro-op 7, other numbers of micro-operations can result from the decoding. In embodiments, the number of micro-operations can include a power of 2.

The pipeline 900 can include a renaming stage 940. The renaming stage can include a rename unit 942. The rename unit takes logical resource names and maps them into available physical resource names. The pipeline 900 can include a dispatch stage 950. The dispatch stage can dispatch one or more micro-operations such as the micro-operations generated by the decode stage to one or more processor cores. The dispatch stage can include a reorder buffer 952. The reorder buffer can keep track of which micro-operation is executing, which micro-operations have completed, which micro-operations have yet to be executed, etc., based on its program counter 954. The reorder buffer can be used to track the execution of the micro-operations if an exception occurs. An exception can occur due to an illegal operation, missing or delayed data, storage access contention, and so on. The pipeline can include an execution stage (not shown). The execution stage can execute the one or more micro-operations that were generated from the vector operation. The execution stage can include a load/store unit (not shown). The load/store unit can load data required by a micro-operation and store data generated by a micro-operation.

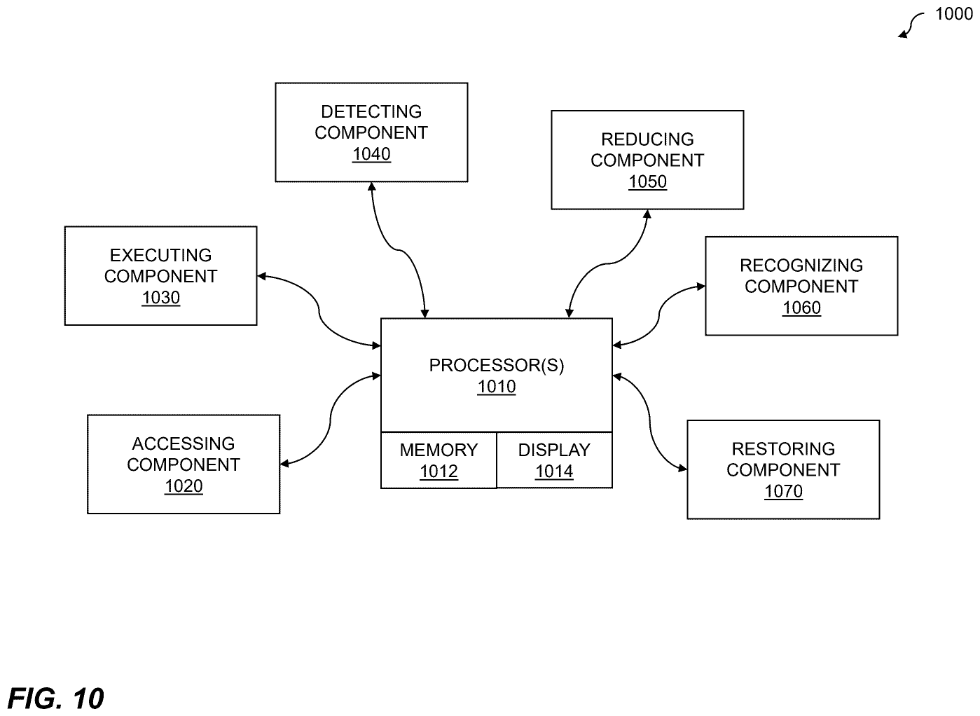

FIG. 10 is a system diagram for starvation avoidance in an out-of-order processor. The system can include one or more of processors, memories, cache memories, displays, counters, and so on. The system 1000 can include one or more processors 1010. The processors can include standalone processors within integrated circuits or chips, processor cores such as cores in FPGAs or ASICs, and so on. The one or more processors can include one or more processors within a system-on-a-chip (SoC). The one or more processors 1010 are coupled to a memory 1012, which stores instructions. The memory can include one or more of local memory, cache memory, system memory, etc. The system 1000 can further include a display 1014 coupled to the one or more processors 1010. The display 1014 can be used for displaying data, instructions, operations, program states, and the like. In embodiments, one or more processors 1010 are coupled to the memory 1012, wherein the one or more processors, when executing the instructions which are stored, are configured to: access one or more processors, wherein the one or more processors include one or more logical partitions; execute, by a processor within the one or more processors, one or more instructions, wherein the processor executes the one or more instructions out of order; detect, by the processor, a deadlock condition, wherein the deadlock condition prevents the one or more instructions from completing, and wherein the deadlock condition occurs in a logical partition within the one or more logical partitions; reduce, in the logical partition, a parallelism of execution, wherein the reducing allows the one or more instructions to complete, and wherein the reducing is based on one or more control bits; recognize that the deadlock condition has ceased; and restore, in the logical partition, the parallelism of execution, wherein the restoring is based on the one or more control bits.

The system 1000 can include an accessing component 1020. The accessing component 1020 can include accessing one or more processors, wherein the one or more processors include one or more logical partitions. The one or more processors can be based on processors in an integrated circuit or chip, programmable or configurable integrated circuits such as an FPGAs or ASICs, etc. In embodiments, a processor core can include RISC-V™ processor core. Each processor within the one or more processors can be coupled to one or more elements such as scratchpad memory, register files, single-level cache, multi-level cache, peripherals, and so on. Each logical partition can be assigned portions of the processor resources and can act as a virtual processor for executing code, applications, etc.

The system 1000 can include an executing component 1030. The executing component 1030 can include executing, by a processor within the one or more processors, one or more instructions, wherein the processor executes, out of order, the one or more instructions. The executing can be accomplished by the processor, by a processor core within the processor, by a logical partition within the processor, and so on. Out-of-order execution can include the processor executing instructions in an order different from an original order specified in the code. Out-of-order execution enables the processor to take advantage of execution enhancements such as parallelism in the code, stall avoidance, and so on.

The system 1000 can include a detecting component 1040. The detecting component 1040 can include detecting, by the processor, a deadlock condition, wherein the deadlock condition prevents the one or more instructions from completing, wherein the deadlock condition occurs in a logical partition within the one or more logical partitions. A deadlock condition can occur within a processor on which two or more processes are executing. The deadlock condition can occur when the two or more processes share resources such as a single-level or multi-level cache, a shared memory system, and so on. The deadlock condition can occur when each process is preventing the other process or processes from accessing the shared resource. The deadlock condition occurs in a logical partition within the one or more logical partitions.

The system 1000 can include a reducing component 1050. The reducing component 1050 can include reducing, in the logical partition, a parallelism of execution, wherein the reducing allows the one or more instructions to complete, wherein the reducing is based on one or more control bits. The reducing parallelism of execution can include executing instructions associated with one process or another, executing instructions in order, and so on. The reducing can allow the one or more instructions to complete. The reducing can eliminate a hold, lock, or other indication that execution of an instruction needs to be held, suspended, delayed, etc. The reducing can be based on one or more control bits. The reducing can force the one or more instructions to execute in order. In embodiments, an instruction within the one or more instructions can include one or more micro-operations, wherein the one or more micro-operations can be executed atomically. A micro-operation can include a memory access, an arithmetic operation, a logical operation, etc. The reducing can include forcing the one or more micro-operations to execute in order. The reducing can include restarting the one or more instructions. The reducing can include decreasing a number of threads running on the processor. The reducing can include limiting one or more shared resources, wherein the one or more shared resources are utilized by at least two of the one or more instructions.

The system 1000 can include a recognizing component 1060. The recognizing component 1060 can include recognizing that the deadlock condition has ceased. The deadlock condition can cease when one or more mitigation techniques, such as the various techniques associated with reducing execution parallelism, were successful in resolving the deadlock condition. The detecting and the recognizing can include comparing a first number of instructions issued by the processor to a second number of instructions completed by the processor. The detecting and the recognizing can be based on an estimated threshold number of cycles required for completion of the one or more instructions. The detecting and the recognizing cam be based on a number of cycles that the one or more instructions have remained in an issue queue within the processor.

The system 1000 can include a restoring component 1070. The restoring component 1070 can include restoring, in the logical partition, the parallelism of execution, wherein the restoring is based on the one or more control bits. Having recognized that the deadlock condition has ceased, the execution parallelism can be restored. How the execution parallelism is restored can be based on what actions were taken to reduce the execution parallelism. The steps to reduction were based on the control bits.

The system 1000 can include a computer program product embodied in a non-transitory computer readable medium for avoiding deadlock, the computer program product comprising code which causes one or more processors to generate semiconductor logic for: accessing one or more processors, wherein the one or more processors include one or more logical partitions; executing, by a processor within the one or more processors, one or more instructions, wherein the processor executes the one or more instructions out of order; detecting, by the processor, a deadlock condition, wherein the deadlock condition prevents the one or more instructions from completing, and wherein the deadlock condition occurs in a logical partition within the one or more logical partitions; reducing, in the logical partition, a parallelism of execution, wherein the reducing allows the one or more instructions to complete, and wherein the reducing is based on one or more control bits; recognizing that the deadlock condition has ceased; and restoring, in the logical partition, the parallelism of execution, wherein the restoring is based on the one or more control bits.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for avoiding deadlock comprising:
accessing one or more processors, wherein the one or more processors include one or more logical partitions;
executing, by a processor within the one or more processors, one or more instructions, wherein the processor executes the one or more instructions out of order;
detecting, by the processor, a deadlock condition, wherein the deadlock condition prevents the one or more instructions from completing, and wherein the deadlock condition occurs in a logical partition within the one or more logical partitions;
reducing, in the logical partition, a parallelism of execution, wherein the reducing allows the one or more instructions to complete, and wherein the reducing is based on one or more control bits;
recognizing that the deadlock condition has ceased; and
restoring, in the logical partition, the parallelism of execution, wherein the restoring is based on the one or more control bits.

2. The method of claim 1 wherein the detecting and the recognizing include comparing a first number of instructions issued by the processor to a second number of instructions completed by the processor.

3. The method of claim 2 wherein the comparing is based on the one or more logical partitions of the processor.

4. The method of claim 3 wherein the one or more logical partitions comprise a functional unit within the processor.

5. The method of claim 1 wherein the detecting and the recognizing include determining that a number of cycles require for completion of the one or more instructions exceeds an estimated threshold number.

6. The method of claim 1 wherein the detecting and the recognizing are based on a number of cycles that the one or more instructions have remained in an issue queue within the processor.

7. The method of claim 1 wherein the reducing includes forcing the one or more instructions to execute in order.

8. The method of claim 7 wherein the reducing includes a serialization of in-order operations.

9. The method of claim 1 wherein the reducing includes non-speculatively fetching instructions.

10. The method of claim 1 wherein the reducing includes serializing an instruction dispatch.

11. The method of claim 1 wherein the reducing includes limiting one or more shared resources, wherein the one or more shared resources are utilized by at least two of the one or more instructions.

12. The method of claim 11 wherein the shared resources comprise a translation lookaside buffer (TLB).

13. The method of claim 1 wherein the reducing includes restarting the one or more instructions.

14. The method of claim 1 wherein the one or more instructions execute on one or more threads running on the processor.

15. The method of claim 14 wherein the reducing includes decreasing a number of threads running on the processor.

16. The method of claim 1 wherein an instruction within the one or more instructions comprises one or more micro-operations, wherein the one or more micro-operations are executed atomically.

17. The method of claim 16 wherein the reducing includes forcing the one or more micro-operations to execute in order.

18. The method of claim 1 wherein the reducing includes a flush of a pipeline within the one or more processors.

19. The method of claim 18 wherein the flush occurs on an instruction boundary.

20. The method of claim 18 wherein the flush occurs on one or more threads executing on the one or more processors.

21. A computer program product embodied in a non-transitory computer readable medium for avoiding deadlock, the computer program product comprising code which causes one or more processors to generate semiconductor logic for:
accessing one or more processors, wherein the one or more processors include one or more logical partitions;
executing, by a processor within the one or more processors, one or more instructions, wherein the processor executes the one or more instructions out of order;
detecting, by the processor, a deadlock condition, wherein the deadlock condition prevents the one or more instructions from completing, and wherein the deadlock condition occurs in a logical partition within the one or more logical partitions;
reducing, in the logical partition, a parallelism of execution, wherein the reducing allows the one or more instructions to complete, and wherein the reducing is based on one or more control bits;
recognizing that the deadlock condition has ceased; and
restoring, in the logical partition, the parallelism of execution, wherein the restoring is based on the one or more control bits.

22. A computer system for avoiding deadlock comprising:
a memory which stores instructions;
one or more processors coupled to the memory wherein the one or more processors, when executing the instructions which are stored, are configured to:
access one or more processors, wherein the one or more processors include one or more logical partitions;
execute, by a processor within the one or more processors, one or more instructions, wherein the processor executes the one or more instructions out of order;
detect, by the processor, a deadlock condition, wherein the deadlock condition prevents the one or more instructions from completing, and wherein the deadlock condition occurs in a logical partition within the one or more logical partitions;
reduce, in the logical partition, a parallelism of execution, wherein the reducing allows the one or more instructions to complete, and wherein the reducing is based on one or more control bits;
recognize that the deadlock condition has ceased; and
restore, in the logical partition, the parallelism of execution, wherein the restoring is based on the one or more control bits.
